(19) United States
(12) Patent Application Publication
(10) Pub. No.: US 2017/0154017 A1
(43) Pub. Date: Jun. 1, 2017

(54) Web Application Management

(71) Applicant: Telefonaktiebolaget LM Ericsson (publ), Stockholm (SE)

(72) Inventors: Johan Kristiansson, Luleå (SE); Stefan Håkansson, Luleå (SE); Michal Koziuk, Upplands Väsby (SE); Johan Sjöberg, Stockholm (SE)

(21) Appl. No.: 15/308,764

(22) PCT Filed: May 8, 2014
(86) PCT No.: PCT/SE2014/050569

§ 371 Date: Nov. 3, 2016

(51) Int. Cl. G06F 17/22; G06F 17/30

(52) U.S. Cl. CPC G06F 17/2247; G06F 17/30899; G06F 3/04817

(57) ABSTRACT

A web application management involves retrieving a meta software container (6) comprising bootstrap code from a DHT (12) based on a web application identifier. The bootstrap code is loaded in a web page (2) to deploy a software container (18) in a container runtime environment (9). Web application code of the web application (5) contained in the deployed software container (18) is loaded in the web page (2) using a web server (7) in the deployed software container (18) to initialize a user interface of the web application (5) in a web browser (1). The web application (5) can thereby be easily transferred and migrated between devices and screens.

### TECHNICAL FIELD

The present embodiments generally relate to web application management, and in particular to management of web applications that are transferable between processing devices across computing platforms.

### BACKGROUND

Contextual communication relates to automatic generation of a communication or collaboration service to allow groups of people to more easily solve a problem together. It is generally about bringing in the “right” information and the “right” tools at the “right” time with the “right” group of people to allow the people to efficiently solve a problem.

A contextual communication service may provide a shared space that allows developers to create special kind of web applications, component or widgets that can be attached to the shared space where the users can simultaneously interact with each other in real-time using the web applications. The web applications can be uploaded to a central repository, thus allowing users to basically build their own customized communication and collaboration tool by manually selecting and attaching appropriate web applications.

However, developing a web application for a contextual communication service is typically not an effortless process. Furthermore, once a web application is attached to a shared space, it cannot easily be transferred to another screen or device. There are also challenges with regard to runtime solutions and Platform-as-a-Service (PaaS) solutions, in particular when more and more devices get interconnected.

An example of a contextual communication service is when a field engineer gets in close proximity to a factory machine, a diagnosis application automatically appears on his/her screen together with the job ticket. The field engineer is also able to send and share the diagnosis application with an expert to remotely troubleshoot the factory machine. The expert would be able to bring up the diagnosis application on a screen in a control center. Information can flow freely between screens, devices, platforms and networks, and form new services whenever needed.

Liquidity of a web application refers to how easily a web application can be transferred to another device, service or system and how much effort must be spent on transferring it. Most of today's web services are illiquid because developers must spend a significant amount of time and effort on customization to make the web application run successfully on different screens and devices. Additionally, it can be cumbersome for end-users to transfer a web application or setting it up on another device. For example the user might need to send a universal resource locator (URL) in an email and then clicking on the URL and login to open it up in another browser window. In this case, the user will simply start the same service but on another device, which is not the same as letting a web application and a user to intuitively and seamlessly take advantage of multiple devices and screens. Strictly speaking, it can be argued that all of today's online web services are illiquid because the web services are inherently incompatible with each other, and could rather be viewed as isolated silos. In general, it is not possible to take a web application, e.g. a Google Doc, and just drag it to another web service.

There are several disadvantages and shortcomings of the present technology. For instance, most of the web and cloud platforms available today do not allow web applications to be effortlessly transferable between systems, e.g. device or screens. Data and server components are typically locked to a specific cloud provider, which cannot easily be changed. Web and cloud platforms are typically based on a centralized architecture and client-server model where servers are deployed in data centers and the web browser just act as thin clients to interact with the servers. The PaaS platforms available today are typically designed only to support Hypertext Transfer Protocol (HTTP) based applications, and are in general very hard to change and customize.

Thus, there is a need to for improvements within the art of web application management.

Román et al., A Middleware Infrastructure for Active Spaces, Pervasive Computing, IEEE, 1(4): 74-83, 2002 discusses the Gaia metaoperating system which extends the reach of traditional operating systems to manage ubiquitous computing habitats and living spaces as integrated programmable environments.

### SUMMARY

It is a general objective to provide a solution to more efficiently manage web application.

It is a particular objective to make it easier to transfer web applications between devices and screens.

These and other objectives are met by embodiments as disclosed herein.

An aspect of the embodiments relates to a web application management method. The method comprises a runtime environment retrieving a meta software container comprising bootstrap code from a Distributed Hash Table (DHT) based on a web application identifier of a web application. The method also comprises the runtime environment loading the bootstrap code in a web page to deploy a software container in a container runtime environment. The method further comprises the runtime environment loading web application code of the web application contained in the deployed software container in the web application using a web server in the deployed software container to initialize a user interface of the web application in a web browser.

Another aspect of the embodiments relates to a web application device configured to retrieve a meta software container comprising bootstrap code from a DHT based on a web application identifier of a web application. The web application management device is also configured to load the bootstrap code in a web page to deploy a software container in a container runtime environment. The web application management device is further configured to load web application code of the web application contained in the deployed software container in the web page using a web server in the deployed software container to initialize a user interface of the web application in a web browser.

A further aspect of the embodiments relates to a web application management device comprising a retrieving module for retrieving a meta software container comprising bootstrap code from a DHT based on a web application identifier of a web application. The web application management device also comprises a bootstrap code loading module for loading the bootstrap code in a web page to deploy a software container in a container runtime environment. The web application management device further comprises a web application code loading module for loading web application code of the web application contained in the deployed software container in the web page using a web server in the deployed software container to initialize a user interface of the web application in a web browser.

Still another aspect of the embodiments relates to a computer program comprising instructions, which when executed by at least one processor, cause the at least one processor to retrieve a meta software container comprising bootstrap code from a DHT based on a web application identifier of a web application. The at least one processor is also caused to load the bootstrap code in a web page to deploy a software container in a container runtime environment. The at least processor is further caused to load web application code of the web application contained in the deployed software container in the web page using a web server in the deployed software container to initialize a user interface of the web application in a web browser.

A related aspect of the embodiments defines a carrier comprising the computer program according to above. In an embodiment, the carrier is one of an electronic signal, an optical signal, an electromagnetic signal, a magnetic signal, an electric signal, a radio signal, a microwave signal, or a computer-readable storage medium.

Web applications management according to the embodiments significantly simplifies transfer of web applications between devices and screens. The embodiments are, for instance, suitable to achieve contextual communication services involving different user devices.

### BRIEF DESCRIPTION OF THE DRAWINGS

The embodiments, together with further objects and advantages thereof, may best be understood by making reference to the following description taken together with the accompanying drawings, in which:

FIG. 1 schematically illustrates an execution environment for a web application;

FIG. 2 schematically illustrates a web application packaged in a software container;

FIG. 3 is an overview of components involved in a web application management method according to an embodiment;

FIG. 4 schematically illustrates implementing runtime environment as a JavaScript library;

FIG. 5 schematically illustrates implementing runtime environment as a web browser extension or plugin;

FIG. 6 schematically illustrates visualization of an icon in a web browser upon detection of presence of a tangible device;

FIG. 7 is a signal diagram illustrating a web application management method according to an embodiment;

FIG. 8 is a signal diagram illustrating a web application management method according to another embodiment;

FIG. 9 is a signal diagram illustrating a web application management method according to a further embodiment;

FIG. 10 is a signal diagram illustrating a web application management method according to yet another embodiment;

FIG. 11 is a signal diagram illustrating removing a web application according to an embodiment;

FIG. 12 is an illustration of an example of DHT deployment;

FIG. 13 is a flow diagram illustrating a web application management method according to an embodiment;

FIG. 14 is a flow diagram illustrating an additional, optional step of the method shown in FIG. 13;

FIG. 15 is a flow diagram illustrating additional, optional steps of the method shown in FIG. 13;

FIG. 16 is a flow diagram illustrating additional, optional steps of the method shown in FIG. 13;

FIG. 17 is a flow diagram illustrating an additional, optional step of the method shown in FIG. 13;

FIG. 18 is a flow diagram illustrating additional, optional steps of the method shown in FIG. 13;

FIG. 19 is a flow diagram illustrating an implementation example of loading web application code in the method shown in FIG. 13;

FIG. 20 is a flow diagram illustrating additional, optional steps of the method shown in FIG. 13;

FIG. 21 is a flow diagram illustrating an additional, optional step of the method shown in FIG. 13;

FIG. 22 is a flow diagram illustrating additional, optional steps of the method shown in FIG. 13;

FIG. 23 is schematic illustration of a web application management device according to an embodiment;

FIG. 24 is schematic illustration of a web application management device according to another embodiment;

FIG. 25 is schematic illustration of a web application management device according to a further embodiment; and

FIG. 26 illustrates a user equipment (UE) according to an embodiment together with a computer program product and computer program according to an embodiment.

### DETAILED DESCRIPTION

Throughout the drawings, the same reference numbers are used for similar or corresponding elements.

The present embodiments generally relate to management of web applications, also referred to as web widgets, web components or simply widgets or web apps in the art. In particular, the embodiments relate to management of web applications that are transferable between processing devices and across computing platforms.

The transferability of a web application is sometimes referred to as liquidity of the web application. A liquid web application can “flow” between devices and screens across computing platforms without substantial amount of time and effort on customization to make it run successfully on different devices and screens.

The web application management of the embodiments is particular suitable, but not limited to, usage in connection with contextual communication services. Contextual communication services imply communication services that are adapted to a current context. Such contextual communication services are about providing the right information and the right tools at the right time with the right group of people to allow the people to efficiently solve a problem.

Prior to discussing the web application management in more detail, a general introduction to some of the technical components used in the embodiments first follows here below.

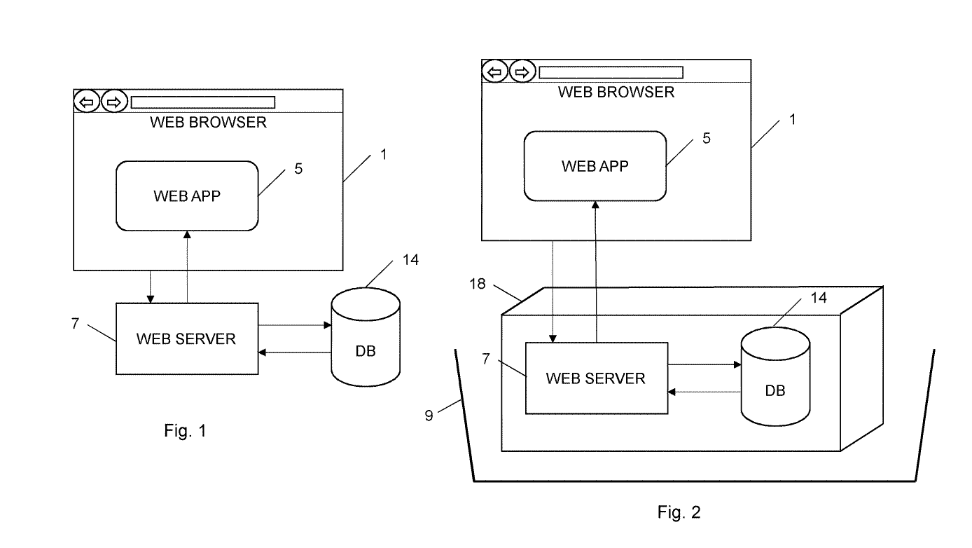

A “web application” 5 as used herein is typically a computer software that runs in a web browser 1, see FIG. 1. A web application 5 can be written in any program code, including HyperText Markup Language (HTML)/Cascading Style Sheets (CSS) markup code and JavaScript loaded from a web server 7 after a user clicks on a link or manually enters a Uniform Resource Locator (URL), i.e. a web address, in the address field of the web browser 1.

FIG. 1 illustrates a simplified execution environment for a web application 5. The web server 7 can either load the software code (HTML/CSS/JavaScript) from the file system as static files, or dynamically generate the software code on the fly, e.g. using a web framework. The web server 7 may also interact with a database (DB) 14 or other web servers to create so called server-side mashups, i.e. a web page or application that uses content from more than one source to create a single new service displayed in a single graphical interface. The web application 5 running the web browser 1 may also interact with multiple web servers to form client-side machups. In both cases, the initial web application code is loaded from a single web server 7 identified by the original URL the user opened or clicked on.

As schematically shown in FIG. 2, a “software container” 18 is a lightweight virtualization technology, which allows system processes to run in an isolated user-space instance on a single computer system. From a system process point of view, i.e. inside the software container 18, the environment looks like an isolated virtual machine, but from outside it is just another process. The advantage of software containers 18 compared to full hardware virtualization is that software containers 18 can instantly be started, stopped, or resumed.

A “meta software container” may comprise meta information, in addition to bootstrap code as defined herein.

Docker [1] is an open source project that simplifies development and deployment of software containers 18. It allows web applications 5 to be packaged as so called container images, which can also extend other container images, i.e. delta images, and thus become very small. The Docker project also provides a Docker Engine, which is an execution environment or a so-called “container runtime environment” 9, which is responsible for executing and managing Docker containers from a standard Linux computer.

FIG. 2 illustrated a web application 5 packaged and running in a software container 18. By deploying a container image, it becomes possible to instantiate a software container 18 in a container runtime environment 9, for example Docker Engine. The container runtime environment 9 can also be a cluster of many container engines running on different hardware. In fact, a whole data center can be modeled as a single container runtime environment. Such clustered container engine can for example be created using the Apache Mesos cluster management framework.

A “Distributed Hash Table” (DHT) is basically a distributed lookup protocol designed to locate a network node where a particular data object is stored. DHTs were originally invented to overcome scalability problems of the first generation unstructured peer-to-peer file sharing networks, such as Gnutella or Kazaa. Another objective was to enable development of fully decentralized peer-to-peer networks, so called overlay networks, without central control.

DHT is also a popular technology to develop highly scalable distributed database systems where the DHT protocol is used to locate a DHT node where a specific key-value pair is stored. This makes it possible to split up a database among a large set of database servers. For example, assume the following key-value pair (or tuple), (myKey, myValue), where myKey is the key and the myValue is the value. A cryptographic hash function, for example SHA-1, produces a hash value of the key (myKey), such as 11ef9e0dd4ca7a06b4d3721ec5b6e3a359848a32.

Based on the hash value of the key, a DHT algorithm can determine which DHT node in a DHT network that is responsible for storing the corresponding value. A common way to achieve these kinds of lookups is to assign each DHT node in the DHT network an identifier of the same hash space as the one used to calculate the hash value of the keys, and then use a distance metric to route lookup message to the responsible DHT node.

Various DHT algorithms have been proposed over the years. As an introduction to DHT, the following text gives a brief description to the Chord algorithm. Chord organizes DHT nodes in the DHT network as a virtual ring, where each DHT node is given an identifier from the same hash space. SHA-1 is used to calculate hash values of the keys. Each DHT node is responsible to store key-value pairs that are closest to the identifier of the DHT node compared to other DHT nodes in the ring.

To locate where a data object (value) is stored, a lookup message is sent clock-wise in the ring to find the DHT node where the data object is stored. To provide better performance, each DHT node maintains so called fingers, i.e. shortcuts in the ring, to other DHT nodes. For example, each DHT node maintains a finger to the other side in the ring and to the closest neighbors. This makes the Chord algorithm highly scalable and efficient. Theoretically, the number of messages that needs to be sent in the ring is O(log(N), where N is the number of DHT nodes.

As mentioned before, the table of fingers needs to be updated when a new DHT node joins the ring or leaves it. However, this does not have to be done immediately, but can be done on a maintenance basis. Note that the internal look up routing will still function correctly even though the finger tables are incorrect, but the routing will not be optimal in this case.

When a new DHT node joins the ring, it will calculate a self-generated identifier, and then calculate a SHA-1 hash of the identifier. Using the hash value it will find its location in the ring. It will then contact adjacent DHT nodes based on its calculated hash value, asking them to become part of the ring. During a so-called stabilization period, the adjacent DHT nodes connect to the new DHT node. The new DHT node will also take over responsibility for some key-value pairs according to the hash value of its identifier from the closest DHT node in the ring.

To provide better robustness and prevent key-value pairs from be lost when a DHT node leaves the ring, key-value pairs are replicated with the closest neighbors. If a DHT node unexpectedly leaves the ring, its responsibility will automatically be taken over by some other DHT nodes. This self-healing aspect is important when developing robust distributed systems.

Kademilla is another DHT algorithm that can be worth mentioning. It is used in the Bittorrent protocol to implement trackerless torrents. The idea is similar to the Chord algorithm, but it uses prefix routing instead of a ring topology, and XOR to locate the closest DHT node given the hash value of a key. An advantage compared to Chord is that Kademilla does not use fingers, which needs be recalculated when a DHT node joins or leaves the peer-to-peer network. The cost of joining or leaving the network is thus zero.

The present embodiments are, however, not limited to the above mentioned DHT algorithms but can rather use any DHT algorithm and network to manage meta software containers as further described.

Kademilla and Chord should therefore be regarded as non-limiting and illustrative examples of DHT algorithms that can be used by the embodiments.

A “runtime environment”, sometimes also referred to as runtime component or runtime system, typically implements the core behavior of a computer language. Every computer language implements some form of runtime environment, whether the language is a compiled language, interpreted language, embedded domain-specific language, or is invoked via an application programming interface (API). In addition to the basic low-level behavior of the language, a runtime environment may also implement higher-level behavior and even support type checking, debugging, or code generation and optimization.

A “container runtime environment” is a runtime environment configured to deploy software containers as shown in FIG. 2.

Bootstrapping usually refers to the starting of a self-sustaining process that is supposed to proceed without external input. In computer technology the term usually refers to the process of loading the basic software into the memory of a computer or processing device after power-on or general reset, especially the operating system which will then take care of loading other software as needed. “Bootstrap code” as used herein relates to instructions contained in a “meta software container” and that are used to deploy a software container. The instructions thereby involve or trigger a chain of events that involves deploying a software container in a container runtime environment to load web application code using a web server all contained within the deployed software container, see FIG. 2. The bootstrap code can thereby be seen as a complete set of instructions required in order to deploy the software container in the container runtime environment ultimately leading up to the initialization of a web application in a web browser.

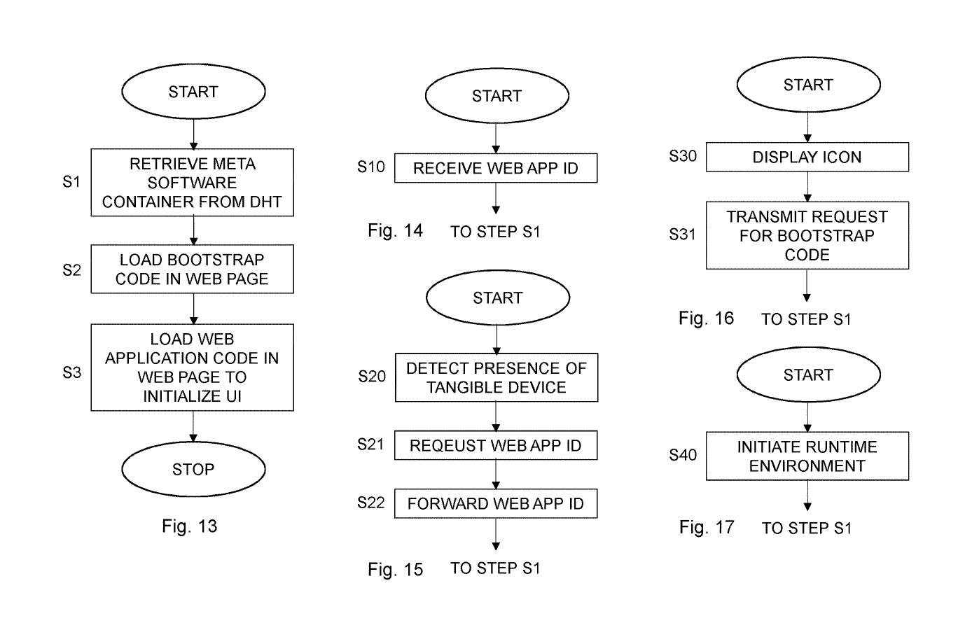

FIG. 13 is a flow diagram illustrating a web application management method according to an embodiment. The method starts in step S1, which comprises a runtime environment retrieving a meta software container comprising bootstrap code from a DHT based on a web application identifier of a web application. A next step S2 comprises the runtime environment loading the bootstrap code in a web page to deploy a software container in a container runtime environment. The runtime environment then loads, in step S3, web application code of the web application contained in the deployed software container in the web page using a web server in the deployed software container to initialize a user interface of the web application in a web browser.

Thus, a main concept of the embodiments is to “package” a web application in a software container and retrieve bootstrap code from a DHT. The bootstrap code is then used to deploy or instantiate the software container and initialize the user interface in a web browser. This means that the bootstrap code obtained from the DHT contains all necessary instructions to run the web application hosted by the software container in the web browser.

Each web application is addressed and identified using a respective web application identifier. In an embodiment, the method comprises the additional and optional step of FIG. 14. In such a case, the runtime environment receives the web application identifier in step S10 from a tangible device controller. The method then continues to step S1 of FIG. 13, where the runtime environment retrieves the meta software container from the DHT using the web application identifier received in step S10.

A “tangible device” is a physical device used herein to store and access the web application identifier. A web application of the embodiments can preferably freely move across web browsers and devices. Such a process is inherently physical since it involves the user moving across the physical space that surrounds the user. The tangible device is then used to serve as an interface between the user and the web application management system.

According to the embodiments, existence or presence of a tangible device is detectable by a tangible device controller. In such a case, the additional, optional steps as shown in FIG. 15 can be performed in the web application management method. The method starts in step S20 where the tangible device controller detects presence of a tangible device. The tangible device controller then requests, in step S21, the web application identifier from the tangible device and forwards the web application identifier to the runtime environment in step S22. The method then continues to step S1 of FIG. 13, where the runtime environment uses the web application identifier to retrieve the meta software container.

The tangible device can be any physical device or object that can carry or otherwise provide the web application identifier. In an example, the tangible device could be a radio frequency identification (RFID) tag or device with the tangible device controller operating as an RFID reader.

RFID tags can be either passive, active or battery-assisted passive. An active RFID tag has an on-board battery and periodically transmits the web application identifier. A battery-assisted passive (BAP) RFID tag has a small battery on board and is activated when in the presence of an RFID reader. A passive RFID tag is cheaper and smaller because it has no battery. In either case, the RFID tag typically stores the web application identifier in a non-volatile memory. In an embodiment, the tangible device controller as RFID reader transmits an encoded radio signal to interrogate the tangible device as RFID tag. The RFID tag receives the message and then responds with the web application identifier.

RFID is an example of a technology that can be used for implementing the tangible device and the tangible device controller. Also other technologies can be used including, automatic identification and data capture (AIDC). AIDC refers to the techniques of automatically identifying objects. Technologies typically considered as part of AIDC include bar codes, RFID, biometrics, magnetic stripes, Optical Character Recognition (OCR), and smart cards. For instance, the tangible device could be a physical device comprising or at least capable of presenting, such as on a display screen, a barcode, OCR, magnetic strip, smart card chip, etc. that can be optically or otherwise read by the tangible device controller.

Also other types of technology including near field communication (NFC) devices and readers and wireless data storage devices and interrogators could be used as tangible device and tangible device controller of the embodiments. Also far field communication (FFC) devices could be used according to the embodiments. For instance, the tangible device could be a mobile telephone, smart phone, PDA or similar mobile communication equipment storing the web application identifier in a memory.

FIG. 16 is a flow diagram illustrating additional, optional steps of the web application management method as shown in FIG. 13. The method generally starts in step S30, which comprises displaying an icon in the web browser in response to the tangible device controller detecting presence of a tangible device. In a next step S31 the runtime environment transmits a request for the meta software container based on a user-initiated activation of the icon. In such a case, the request comprises the web application identifier. The method then continues to step S1 of FIG. 13 or to step S21 of FIG. 15.

Thus, in this embodiment an icon, symbol or other visual representation of the tangible device or the web application is preferably presented in the web browser once the tangible device controller detects presence of the tangible device. This presented icon then indicates for a user that the tangible device is accessible and that the web application identified by the web application identifier housed in the tangible device can now be installed in the web browser. In a preferred embodiment, the user then utilizes a user input device, such as key pad, mouse, keyboard or touch-sensitive screen, connected to a processing device, which in turn comprises or is connected to a screen in which the web browser and icon are displayed. The user thereby uses the user input device to activate the icon, for instance by clicking on a key when a cursor is positioned on the icon or by dragging-and-dropping the icon to, for instance, a contextual communication application (CCA) portion or window area of the web browser. In either case, the user-initiated activation of the icon preferably triggers the runtime environment to transmit a request for the meta software container towards the DHT and where the request comprises the web application identifier as retrieved from the tangible device using the tangible device controller.

FIG. 17 is a flow diagram illustrating an additional, optional step of the web application method. The method starts in step S40, which comprises initiating or launching the runtime environment in the web browser. The method then continues to step S1 of FIG. 13 or indeed to the any of the additional steps S10, S20 or S30 of FIGS. 14-16.

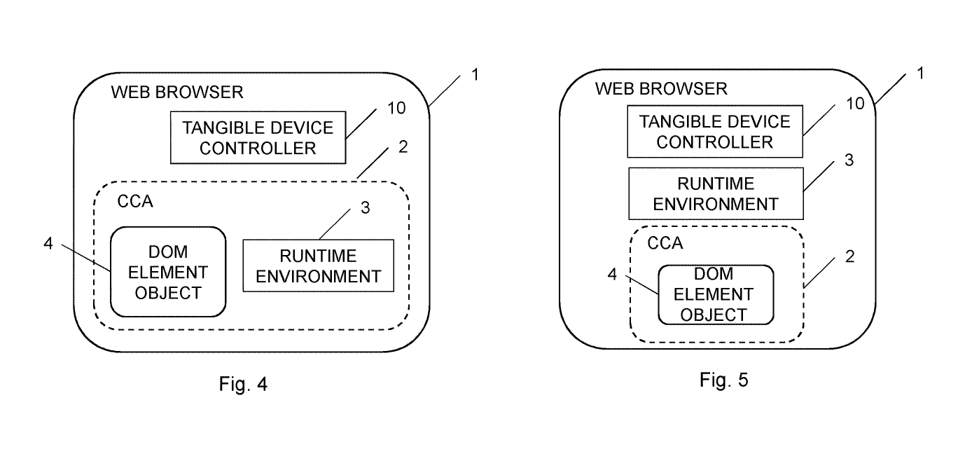

The component runtime environment is preferably responsible for executing and deploying the actual software container and launching the user interface of the web application in the web browser. Parts of the runtime environment 3 may be implemented as a JavaScript library running in the web browser 1, such as loaded as a part of a default web page or a contextual communication application (CCA) page 2 of the web browser 1, see FIG. 4. In such a case, initiating the runtime environment in step S40 may comprise loading a JavaScript library as a part of a CCA page 2 of the web browser 1.

Another solution would be to use a browser extension or plugin of the web browser 1 as schematically shown in FIG. 5. In such a case, step S40 of FIG. 17 preferably comprises initiating the runtime environment 3 as a browser extension or plugin of the web browser 1.

In an embodiment, the runtime environment 3 could be initiated by a user-initiated activation of the previously mentioned user input device. Alternatively, an automatic initiation of the runtime environment 3 could be used, such as triggered by detection of the tangible device. In such a case, step S40 of FIG. 17 preferably comprises a tangible device controller 10 launching the runtime environment 3 in the web browser 1 in response to the tangible device controller 10 detecting presence of a tangible device.

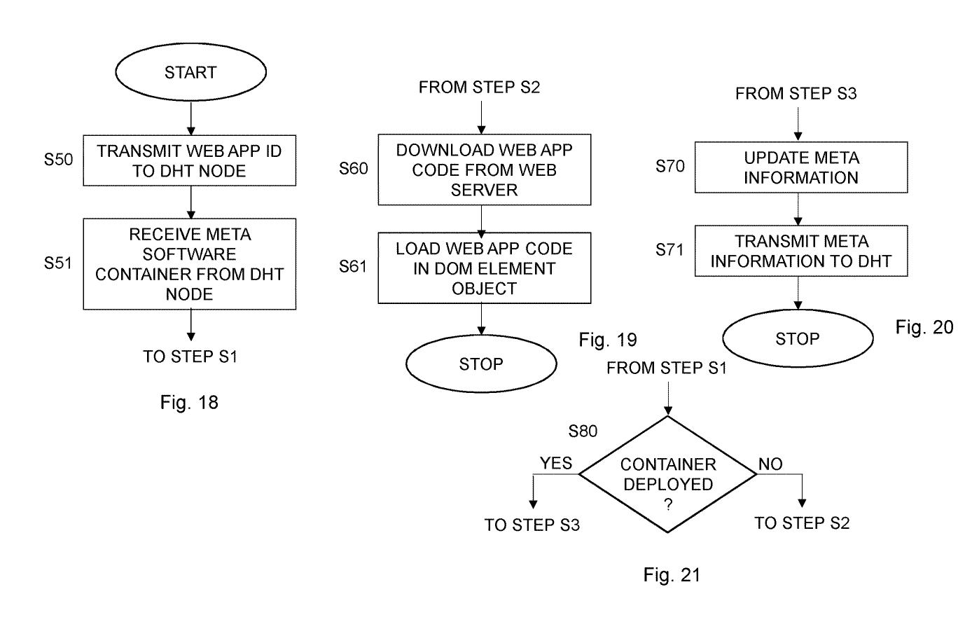

FIG. 18 is a flow diagram illustrating an implementation embodiment of step S1 in FIG. 13. In this implementation embodiment the runtime environment transmits the web application identifier to a DHT node in step S50. In a next step S51, the runtime environment receives the meta software container originating from a DHT node responsible for a range of identifier values encompassing the web application identifier.

Thus, a so-called DHT network of DHT nodes is accessible for storing meta software containers of different available web applications. In such a case, a given DHT node of the DHT network has the responsibility of storing and providing meta software containers having the respective associated web application identifiers that are within the range of identifier values assigned to the given DHT node. Various DHT algorithms are available in the art as previously discussed herein in order to identify the correct DHT node given the web application identifier as key, or typically more correctly given a hash value of the web application identifier as key.

As a consequence, the DHT node to which the runtime environment transmits the web application identifier in step S50 does not need to be the DHT node that actually stores the meta software container identified by the web application identifier. In such a case, the request for the meta software container, i.e. the web application identifier, is routed through the DHT network until it reaches the responsible DHT node that, in response to the web application identifier or request, retrieves the meta software container and forwards it towards the runtime environment.

In an implementation embodiment, step S2 of FIG. 13 comprises the runtime environment triggering the container runtime environment to retrieve a container image to deploy the software container in the container runtime environment.

“Container image” as used herein refers to a copy of the entire state of the software container stored in a non-volatile form, such as a file. This means that the container runtime environment can use the container image in order to deploy the container in the container runtime environment.

As used herein, a “software container” hosts a web server from where the web application source code can be loaded. In addition to the web server, the software container may optionally provide additional server components, such as a Web Real-Time Communication (WebRTC) video conference server, or any other kinds of server components.

The container image may be housed in various locations according to the embodiments. For instance, in an embodiment the container image is stored in a remote image repository configured to store container images. In such a case, the runtime environment preferably triggers the container runtime environment to download the container image from a remote image repository to deploy or install the software container in the container runtime environment.

Alternatively, the meta software container may itself comprise the container image. In such a case, the runtime environment preferably triggers the container runtime environment to retrieve the container image from the meta software container to deploy the software container in the container runtime environment.

In the former example, the meta software container can be made smaller since it does not need to include the container image. However, that solution requires the presence of an image repository that is configured to store container images for various web applications. The latter example relaxes the need for the image repository but requires the meta software container to contain the container image in addition to the bootstrap code.

FIG. 19 is a flow diagram illustrating an implementation embodiment of step S3 in FIG. 13. Hence, the method continues from step S2 of FIG. 13. A next step S60 comprises the runtime environment downloading the web application code from the web server in the deployed software container. In a next step S61 the runtime environment loads the web application code in a Document Object Model (DOM) element object to deploy the web application in the web browser.

The software container 18 deployed in the container runtime environment 9 houses a web server 7 as shown in FIG. 2. The runtime environment can thereby download the source code of the web application 5 from this web server 7. The web application code could for instance be in HTML, CSS and/or JavaScript as illustrative but non-limiting examples. The runtime environment can then load or inject the downloaded web application code in a DOM element object, sometimes also referred to as DOM document, DOM tree or browser environment. Loading the web application code in the DOM element object causes the user interface of the web application to be shown on the web page in the web browser 1 and thereby the web application 5 will be deployed in the web browser 1.

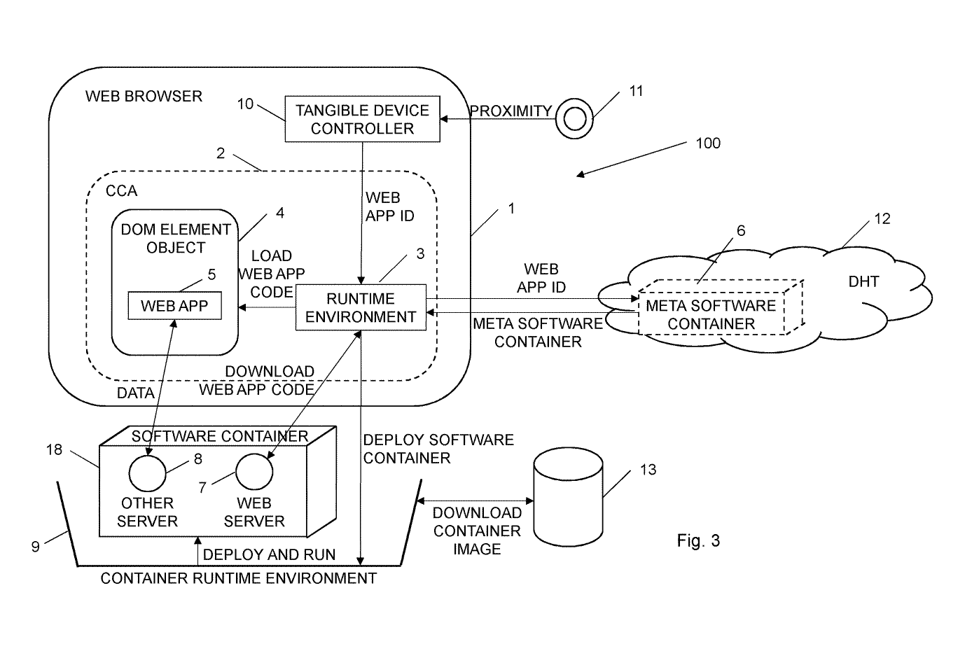

Depending on the backend requirements of the web application 5, the deployment of the software container 18 in the container runtime environment 9 may also trigger access to at least one backend server 8 in addition to the web server 7 as schematically shown in FIG. 3. This at least one backend server 8 could, for instance, be in the form of a WebRTC video conference server or an Apache server as mentioned in the foregoing. In addition, or alternatively, deployment of the software container may trigger deployment of additional software containers. For instance, some components may have multiple instances deployed, e.g. Apache servers, while others will only exist as a single instance, e.g. a MySQL database. The number of software containers therefore does not have to be equal to the number of instances of the web application—rather it could be determined by other means, for instance load balancing mechanisms and defined application requirements. Generally, this behavior, i.e. the deployment of one or more software containers per web application, is preferably determined by the bootstrap code in the meta software container as obtained from the DHT.

Hence, in an embodiment, the runtime environment loads the web application code in the web page, such as DOM element object of the web page, using the web server and at least one backend server in the deployed software container to initialize the user interface in the web browser. In another embodiment, the runtime environment loads the web application code in the web page using the web server in the deployed software container and at least one other server, such as backend server, in another software container deployed in said container runtime environment based on loading the bootstrap code in the web page.

FIG. 20 is a flow diagram illustrating additional, optional steps of the web application management method of FIG. 13. The method continues from step S3 of FIG. 13. In a next step S70, the runtime environment updates meta information of the meta software container with deployment data. The runtime environment then preferably uploads the meta information at the DHT in step S71.

In this embodiment, the runtime environment, once it has installed a web application, provides meta information of the meta software container with so-called deployment data. This means that the meta software container, in this particular embodiment, preferably not only comprises the bootstrap code used to install the web application but also meta information of the web application. The meta information preferably comprises deployment data, in other words information or data descriptive of whether the web application has already been deployed or installed. In an embodiment, the meta information could then comprise connection information to the web server running inside the software container, from which the web application code can be obtained. For instance, the meta information could comprise an URL to the web application code in the web server, such as source-code: http://150.132.140.121:8000.

This means that once the web application has been installed the runtime environment preferably provides deployment data, such as URL, from where the web application code can be obtained from the web server in the deployed software container. This deployment data is then used to update the meta information comprised in the meta software container that is stored at the DHT.

This means that when the meta software container is received the runtime environment can review the meta information contained therein in order to determine whether the web application has already been installed and that there is an active deployed software container with web server from where the web application code can be fetched without the need to redeploying the software container in the container runtime environment.

FIG. 21 schematically illustrates this concept according to an embodiment. In this embodiment the method starts in step S1 of FIG. 13, which comprises the runtime environment retrieving the meta software container comprising the bootstrap code and meta information from the DHT based on the web application identifier. The method then continues to step S80, which comprises the runtime environment determining whether the software container has already been deployed in the container runtime environment based on the meta information. If the software container has not already been deployed as determined based on the meta information, the method continues to step S2 in FIG. 13, which comprises the runtime environment loading the bootstrap code in the web page to deploy the software container in the container runtime environment. However, if the software container has already been deployed the method preferably continues from step S80 to step S3 in FIG. 13, which comprises the runtime environment loading the web application code of the web application contained in the deployed software container in the web page using the web server in the deployed software container to initialize the user interface of the web application in the web browser. In a preferred embodiment, this step S3 comprises the runtime environment loading the web application code from the web server identified based on deployment data of the meta information.

FIG. 22 is a flow diagram illustrating additional, optional steps of the web application management method during removal of the web application. The method continues from step S3 of FIG. 13. In a next step S90, the runtime environment removes the web application from the web page and removes, in step S91, the software container from the container runtime environment. The runtime environment preferably also triggers, in step S92, the container runtime environment to store a container image in a remote image repository. The runtime environment preferably receives an updated web application identifier for the web application from the container runtime environment in step S93 and uploads bootstrap code and the updated web application identifier for the web application at the DHT in step S94.

Here below various implementation examples of the embodiments will be further described.

FIG. 3 is an overview of implementation components of an embodiment and how the implementation components interact when installing or attaching a web application 5 to a web page 2 of a web browser 1, such as in a DOM element object 4. Generally, a tangible device controller 10 detects presence of a tangible device 11 and receives or reads the web application identifier from the tangible device 11. The web application identifier is forwarded from the tangible device controller 10 to the runtime environment 3. The runtime environment 3 provides an API to bootstrap the web application 5 by providing the web application identifier of the web application 5. Thus, the runtime environment 3 will lookup the web application identifier in the DHT 12 to retrieve the meta software container 6 preferably comprising the bootstrap code and meta information in order to deploy the associated software container 18. Thus, the runtime environment 3 uses the received bootstrap code to deploy the software container 18 in the container runtime environment 9. The container runtime environment 9 thereby downloads a container image, such as from a container image repository 13 in order to deploy the software container 18 with its web server 7 and optional other server 8. After the software container 18 is deployed, the runtime environment 3 fetches or downloads the web application code from the web server 7 and injects or loads the web application code into a DOM element object 4, preferably of the CCA page 2. After this procedure is completed, the web application user interface will be shown on the web page, i.e. in the DOM element object 4 as shown in FIG. 5. The web application 5 may optionally access data from the other server(s) 8 in the software container 18, depending on the type of web application 5.

In order to obtain the web application identifier the runtime environment 3 communicates with the tangible device 11 that holds the web application identifier. For this purpose the tangible device controller 10 is preferably used. For a desktop type operating system, such as Windows, Linux or OS X, the tangible device controller 10 could be implemented as a background demon process or a web browser plugin that would communicate with the runtime environment 3 over a local socket. On a mobile platform the tangible device controller could be implemented as a custom browser or a background service much like on a desktop platform could be used.

The previously mentioned FIGS. 4 and 5 illustrate various implementation alternatives for the runtime environment 3. In FIG. 3, the runtime environment 3 is implemented as a JavaScript library that is loaded as a part of a CCA page 2 in the web browser 1, whereas in FIG. 5 the runtime environment 3 is implemented as a browser extension or plugin.

The runtime environment provides an API that the CCA can use to attach a web application. The only information that is required is the web application identifier of the web application and optionally a reference to the DOM element object where the web application should be attached. Optionally, a credential, e.g. password or a certificate, to access the DHT could be provided. For example

<script>
var domId=document.getElementById(“dom_id”);
runtime.attach(“#d4dbf33abf34bda7ef47231a7507372e2c908d6”, domId, cert)
   </script>

In this example, “#d4dbf33abf34bda7ef47231a7507372e2c908d6” represents the web application identifier and domId represents an identifier or reference to the DOM element object.

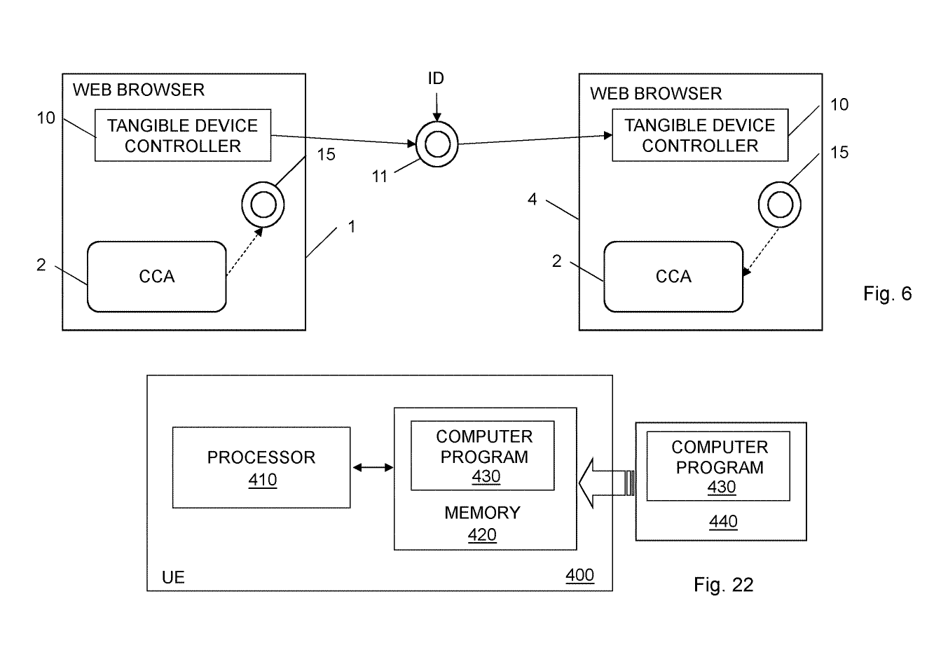

The runtime environment may also provide an API that the CCA 2 can use to interact with the tangible device 11, for example an API to notify when a new tangible device 11 is nearby, and an API to store or read web application identifiers from the tangible device 11. FIG. 6 illustrates how the CCA 2 can use the API provided by the tangible device controller 10 to allow the user to interact with tangible device 11. For example, an icon 15 representing the tangible device 11 may appear in the web browser 1 once the tangible device controller 10 detects the tangible device 11.

When the tangible device 11 gets in proximity to the tangible device controller 10, the icon 15 could appear in the CCA user interface, for instance using the runtime environment API. In this case, the user may be able to drag-and-drop a web application to the icon to store the web application identifier of the web application in the tangible device 11 as indicated in the left part of FIG. 6. Thus, in such a case, the user could drag-and-drop an icon (not shown) of the web application as shown in the user interface of the CCA 2 towards the icon 15 of the tangible device 11. This user-initiated procedure triggers the runtime environment to forward the web application identifier of the web application to the tangible device controller 10, which in turn forwards the web application towards the tangible device 11 for storage therein.

Similarly, a user may be able to drag-and-drop a web application virtually stored in the tangible device 11 to the CCA 2. From an end user point of view, it would almost be like the web application is actually stored in the tangible device 11 although the only thing being stored is the web application identifier. From an end-user perspective, the tangible device 11 would almost be perceived as a USB memory to transfer web application between devices.

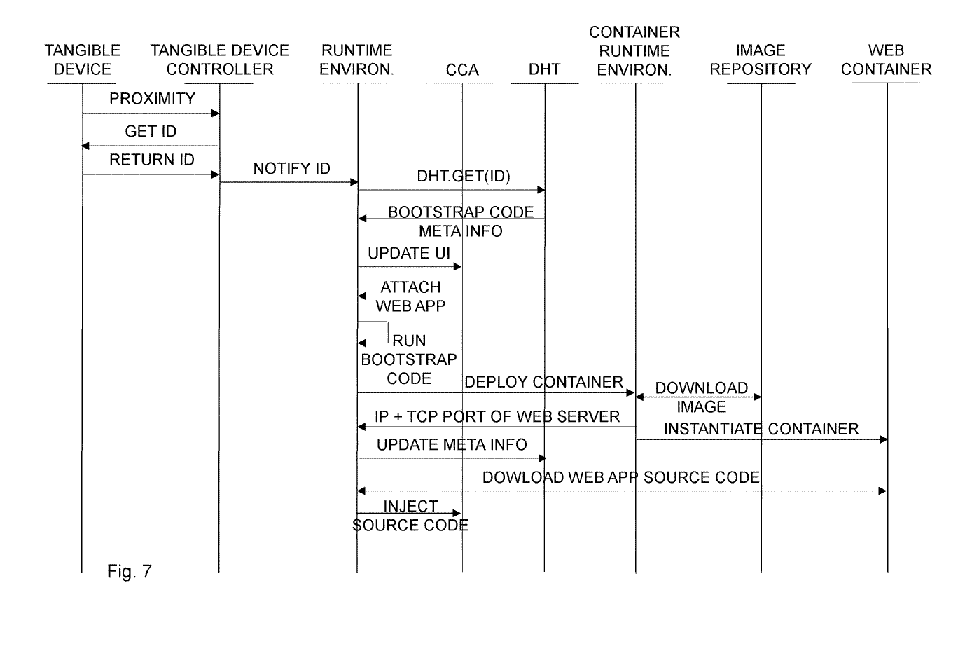

FIG. 7 is a signal diagram illustrating a web application method according to an embodiment. The tangible device controller detects presence of the tangible device and requests the web application identifier therefrom. After the tangible device controller has obtained the web application identifier from the tangible device, it notifies the runtime environment about the web application identifier. The runtime environment will then use the web application identifier to retrieve the bootstrap code and meta information in the meta software container from the DHT. The web application identifier is thereby used as a key in a DHT algorithm in order to identify the DHT node storing the meta software container. The DHT node will return the bootstrap code and meta information about the web application packaged in the form of the meta software container. The meta information can, for instance, be represented as JavaScript Object Notation (JSON) or eXtensible Markup Language (XML), or using some other text format.

The meta information preferably contains generic information about the web application, e.g. a generic description or icon. The meta information also contains deployment data if the web application has already been deployed, that is, connection information to a web server running inside a software container where the web application code can be obtained. For example,

{id: d4dbf33abf34bda7ef47231a7507372e2c908d6, description: “video conference”, source-code: “http://150.132.140.121:8000”, bootstrap: “container_runtime deploy cmm/v10”, contrainer_runtime: “farmer.ericsson.com”}

The container_runtime attribute in the aforementioned bootstrap code can reference a local container runtime environment, e.g. a Docker Engine running as a plugin in the web browser or in a device in the surroundings, e.g. factory machine. Additionally, it can reference a clustered container runtime environment running in a data center with a large amount of underlying container runtime environments connected to it. In later case, the clustered container runtime environment is also responsible for scheduling the software container to run on a suitable underlying container runtime environment.

The runtime environment preferably updates a user interface (UI) of the CCA, for instance by showing an icon representing the web application. The user could then select to install the web application, for instance by activating the icon, such as by drag-and-drop it to the CCA UI or a selected part of the CCA UI.

The runtime environment is responsible for running the bootstrap code if the source code entry is lacking in the meta information, which means that the associated software container hosting the web application is not deployed yet. In order to run the bootstrap code, the runtime environment needs to have access to a suitable container runtime environment. An option is to pass connection information and credentials from the web server where the runtime environment is loaded. Another option may be to store this information on the tangible device.

In order to deploy the software container, the runtime environment injects and runs the bootstrap code in the web page. This causes the container runtime environment to download a container image, such as from a container image repository.

After the container runtime has deployed the software container (it can also be multiple software containers), it will pass connection information to the web server running inside just deployed software container. Thus, the container runtime environment provides information of the internet protocol (IP) and transmission control protocol (TCP) ports to the web server inside the software container to the runtime environment. The runtime environment may then update the (source-code) attribute in the meta information and update the DHT. Note that this operation is preferably blocking to avoid deploying multiple software containers, if two or more runtime environments running on different device tries to attach a web application at the same time.

The runtime environment will then download the source code to the web application from the web server in the just deployed container, preferably based on the received information of IP and TCP ports, and finally inject it into a DOM element object on the web page, and in particular into the DOM element object in the CCA.

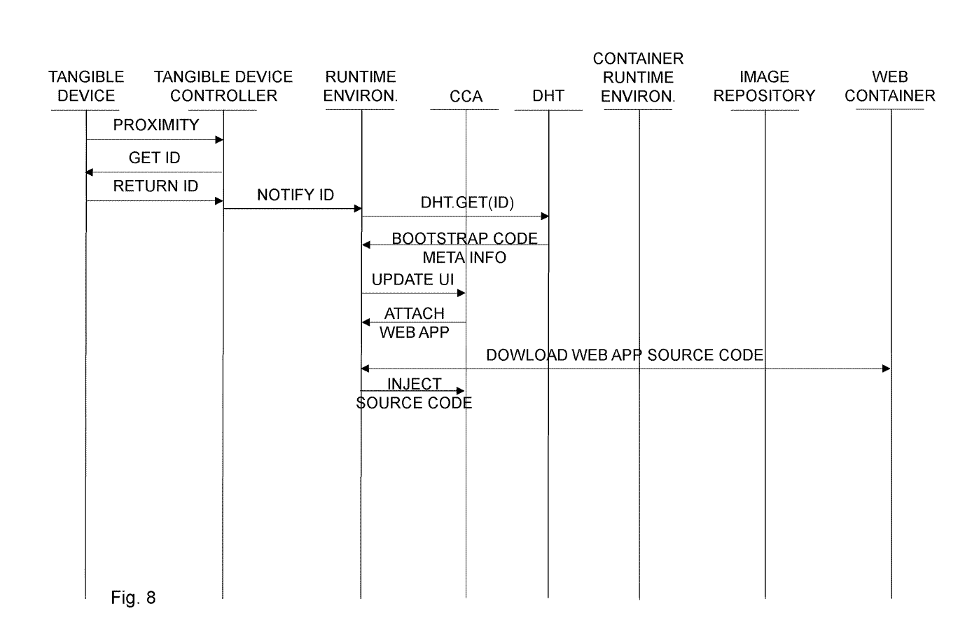

FIG. 8 illustrates a signal diagram of attaching a web application to a web page when the associated software container has already been deployed. In this embodiment, the signaling is substantially the same as shown in FIG. 7 up to the user chooses to attach the web application. If the associated software container is already deployed, there is no need to run the bootstrap code again. In this case, connection information to the web server running inside the already deployed software container can be obtained directly from meta information stored as part of the meta software container in the DHT. As mentioned before, the web server is used to download the actual web application source code that should be injected into the web page or DOM object element.

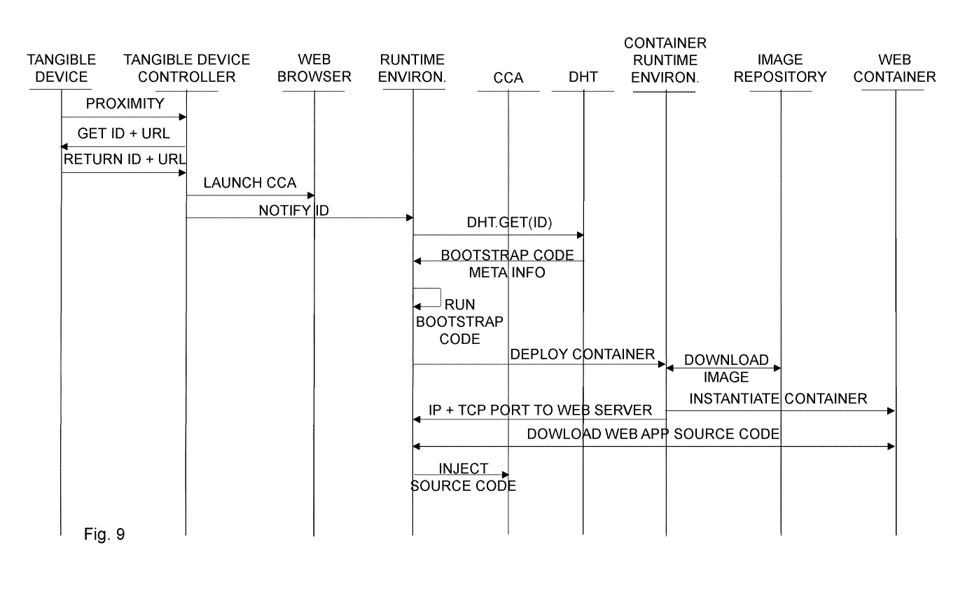

In another embodiment and as shown in FIG. 9, the tangible device controller may simply launch the CCA, such as a new CCA web page in the web browser directly instead of attaching a web application icon to an already running CCA or web page. In this case, the URL to CCA is preferably obtained from the tangible device. The tangible device controller would then ask the web browser to open the URL to launch the CCA and then attach the web application to the CCA in a single operation without user intervention as shown in FIG. 9.

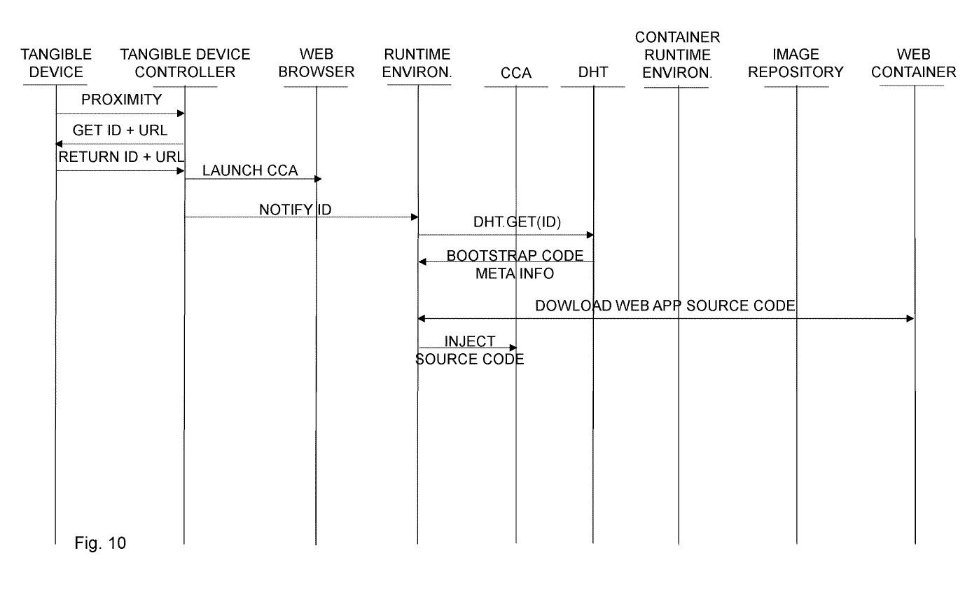

FIG. 10 is basically a combination of FIGS. 8 and 9 and corresponds to a case when the bootstrap code has already been run and the associated software container is already deployed. In this case, connection information to the web server running in the deployed software container is obtained from the meta information stored in the DHT.

A web application can be removed in two different ways. In “soft removal” it is only removed from the DOM element object on the web page. The associated software container is, thus, still running. In a “hard removal”, the web application code is removed from the DOM element object and the associated software container is also removed from the container runtime environment. However, before the software container is removed, the software container is preferably commit, which means that software container is saved as a container image in the container image repository. This is analogous to a snapshot procedure on a virtual machine. Next time the web application is attached (resumed), the same application data stored in the software container will be used.

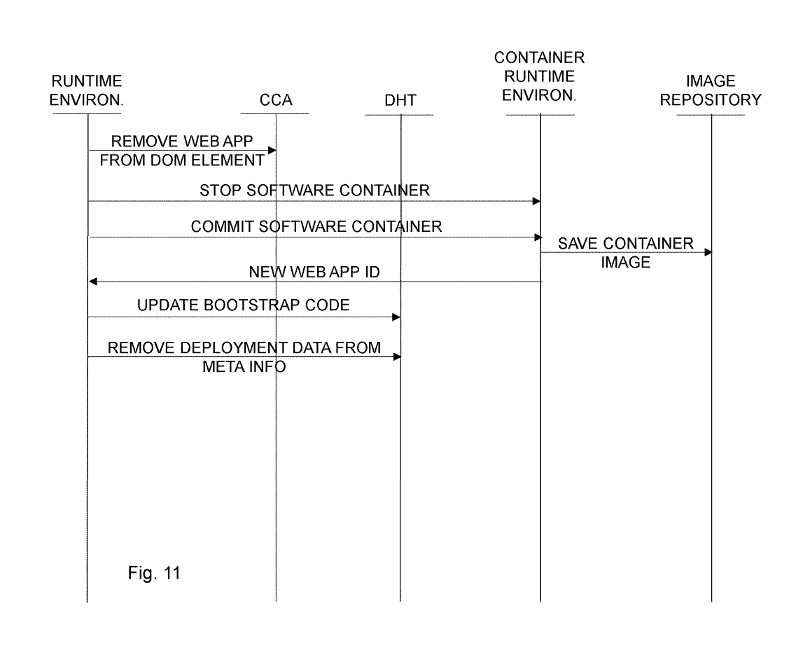

FIG. 11 shows a signal diagram of a hard removal procedure. The runtime environment removes the web application from the DOM element object and stops and commits the software container. In an embodiment, the container image gets a web application identifier after being committed. This means that the runtime environment preferably updates the bootstrap code to ensure that the latest container image is used. The deployment data is also removed from the meta information stored at the DHT to indicate that no software container is currently deployed for the web application.

Note that this procedure can also be used to copy an entire web application. For example, a user may copy an entire web application, including any backend servers and databases running in the software container, just by knowing the web application identifier. This could open up for new interesting use cases, for example the creation of a pervasive cloud platform where users can go in a real physical retail shop and by software by touching a tangible device, and then deploy the web application on the user's own cloud platform.

Various options are possible when it comes to deployment of the DHT. As the DHT is completely distributed, it actually consists of multiple DHT nodes. Therefore it makes more sense to talk about a DHT network. From a practical point of view, it would make sense to integrate the DHT node with the container runtime environment or the container image repository. In the later case, it would also be possible to store container images in the DHT together with the meta information and bootstrap code. Another option would be to run a DHT node in the web browser itself, or perhaps integrate it with a physical device, e.g. a factory machines or an excavator, to build a fully distributed environment.

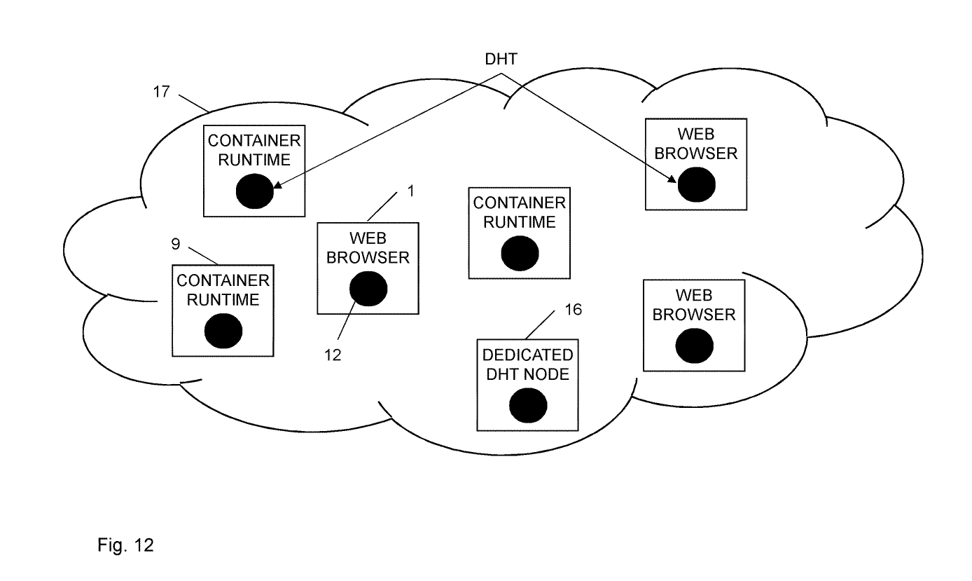

FIG. 12 illustrates various options to deploy the DHT. To make a comparison, one could think about the DHT as Bittorrent network, but instead of distributing file, the DHT network is used to distribute meta software containers. Similar to Bittorrent, everyone contribute to the Bittorrent network. Note that even if it theoretically would be possible to make a complete distributed and de-centralized deployment, it would also be possible to deploy all DHT nodes in one or several data centers to have more control of the system. The figure schematically illustrates a DHT network 17 with DHT nodes 12 implemented, for instance, in container runtime environments 9, web browsers 1 and/or as dedicated DHT nodes 16.

The present embodiments provide technology that enables package and execution of web applications as self-contained and self-managed bundles that can easily be attached to a shared space, such as a contextual communication service, by knowing the web application identifier. The present technology also provides a distributed and decentralized architecture that allows web applications to be globally addressed, stored, looked up, and bootstrapped. These tasks include initializing the frontend, i.e. graphical user inter face (GUI), and starting the backend, i.e. deploying and configuring web servers, database servers, video conference servers etc. This is possible by letting each web application have an assigned web application identifier, which is used to retrieve bootstrap code in the DHT. The bootstrap code in the DHT is dynamically injected into an existing web page, for example a CCA web page, to deploy a software container and then load and inject the actual web application code, such as HTML/CSS/JavaScript, to the CCA using a web server in the deployed software container. In this way, each web application becomes completely self-contained and self-managed. From this point of view, each web application can manage its own mini cloud environment.

Sharing and migrating a web application to another device is possible according to the embodiments by assigning each web application a web application identifier that is stored in a tangible device using e.g. iBeacons/NFC or a QR/bar code. As it is possible to attach a web application by knowing its web application identifier, a web application can be migrated to another device just transferring the web application identifier using the tangible device.

The present technology enables developing highly dynamic web applications that can easily be transferred between devices and screens. The only information that is needed to transfer a web application is the web application identifier. The web application identifier can be stored in barcodes or transferred using RFID-like NFC or iBeacons as illustrative examples.

The embodiments allow a client side web application to also manage and deploy its own backend or infrastructure on demand, which dramatically decreases the complexity of a cloud platform. Basically, it allows a Platform-as-a-Service (PaaS) to be controlled and managed by a web application running in the web browser. In this way, the PaaS can be completely customized for each web application rather than relying on a generic general-purpose platform.

Particular embodiments allow for higher order of automation. For example, a web server can generate JavaScript code that in turn generates the code that manages and deploys backend servers and/or services.

An advantage of using a DHT to implement the provision of meta software containers is that it makes possible to implement a de-centralized architecture that is loosely connected similar to Bittorrent. Instead of providing a centralized cloud service where developers upload their web application, they can just store, deploy and run their software containers anywhere as long as they store the bootstrap code in the DHT. This could be an important property when developing a contextual communication service that is cross-organizational.

Another advantage of the embodiments is that is based on software containers, which means that anything, i.e. media servers, databases etc., could run in the software containers. That is, the proposed solution is not limited to some specific language or frameworks.

### IMPLEMENTATION EXAMPLES

Some use cases illustrating how the embodiments can be put into practice for providing various web applications and services are presented below.

### Implementation Example 1

A user gets an invitation in an email to an online video conference meeting. He/she decides to store the invitation on his/her tangible device. When the meeting is about to begin, the user goes to the conference room where a TV display and conference computer is installed. The conference computer runs a CCA in a web browser that makes it possible to attach and share web applications with other users also running the same CCA service. He/she then touches a tangible device controller with his/her tangible device and the video conference web service provided by a web application suddenly appears on the TV screen.

What is actually happening is that the web application identifier of the web application, here in the form of a video conference application, is stored on the tangible device. When the user touches the tangible device controller, the runtime environment running on the conference server retrieves and runs the bootstrap code to actually deploy the video conference backend server and attach it to the CCA service.

During the same meeting, another user starts to make meeting notes using another web application running locally on his/her tablet. As the meeting notes application is based on Etherpad and has support for collaborative editing, multiple users can type at the same time, assuming they have the URL to the meeting notes service and can log in to it.

The user then decides to share the meeting notes during the meeting. As the tablet also has a built-in tangible device, he/she just touches the tablet against the tangible device controller and suddenly the meeting notes appears on the TV display as well. A third user decides to help out with the meeting notes. He/she right-click on the meeting notes to show a barcode. He/she then scans the barcode using his smart phone, and suddenly the meeting notes application appears on his/her smart phone. After the meeting, he/she copies the web application (notes application) to get a private copy of the meeting notes that nobody else can edit.

### Implementation Example 2

A field engineer is going to repair a broken tractor stranded in a forest. The tractor has its own built in diagnostic tool. Since the tractor may be at a location where there is no converge, the data cannot be uploaded to a centralized server. However, the tractor provides a container runtime environment hosting the diagnostic tool, which is actually a web application. The field engineer just have to bring up his/her tablet and touch a NFC tag to bring up the diagnostic tool on the tablet screen. After the field engineer fixes the problem he/she decides to copy the diagnostic tool so that he/she can look at the data at a later occasion. This is possible by “migrating” the diagnostic tool to another container runtime environment, e.g. running on the tablet. Another advantage of the proposed invention is to enable the field engineer to share CCA with some colleague to resolve the problem. This however requires that diagnosis tool in this case has built in support for real-time sharing.

### Implementation Example 3

In the early 21^{th} century, most software and media is acquired from so called app stores, for example Apple App Store or Google Marketplace. The “old” way of buying software in retail shops was completely replaced with the online app stores, completely changing traditional distribution channels. However, the proposed technology opens up for an alternative way of buying or acquiring software and media that is a combination of the “old” way and the “new” way.

A user is walking around downtown Stockholm. On a poster he/she sees an ad for an interesting game he/she has not played before. By scanning the barcode on the poster, he/she can buy the game, which is a web application, and then he/she can deploy the game on his/her preferred cloud platform. Actually, the user has his/her own cloud server, functioning as container runtime environment, at home that he/she decides to use for hosting the game.

This means that companies can easily distribute software without being dependent on e.g. Google or Amazon. They basically just need to provide the bootstrap code and the software container image of the web applications they are selling, including making sure the associated container images are available on some server somewhere. End-users can choose to use their own cloud platform.

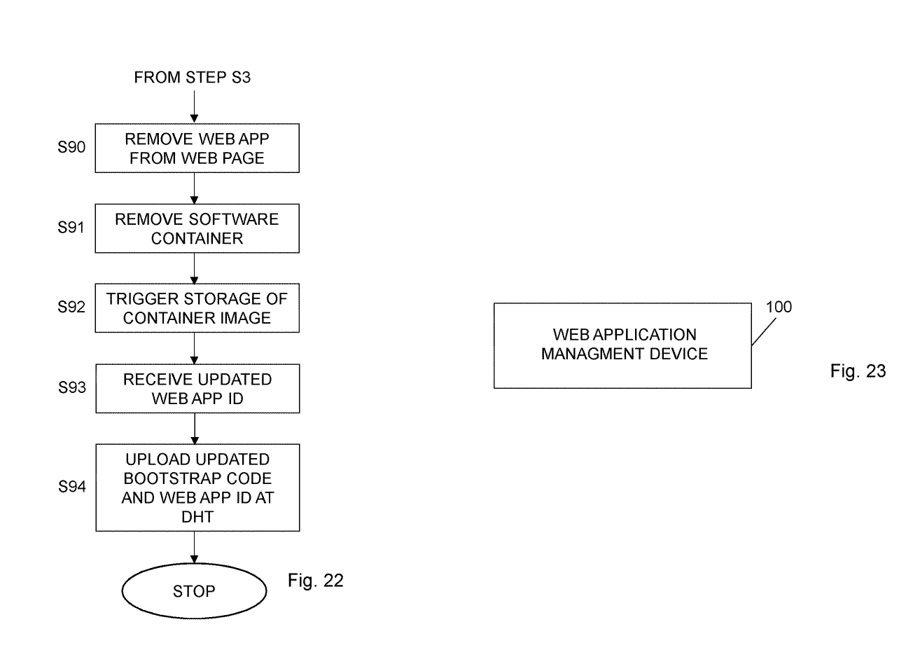

Another aspect of the embodiments relates to a web application management device 100 as schematically illustrated in FIG. 23. The web application management device 100 is configured to retrieve a meta software container comprising bootstrap code from a DHT based on a web application identifier of the web application. The web application management device 100 is also configured to load the bootstrap code in a web page to deploy a software container in a container runtime environment. The web application management device 100 is additionally configured to load web application code of the web application contained in the deployed software container in the web page using a web server in the deployed software container to initialize a user interface of the web application in a web browser.

In an embodiment, the web application management device 100 is configured to detect presence of a tangible device and request the web application identifier from the tangible device.

In an embodiment, the web application management device 100 is configured to display an icon in the web browser in response to detecting presence of the tangible device. The web application management device 100 is also configured, in this embodiment, to transmit a request for the meta software container based on a user-initiated activation of the icon using a user input device connected to the web application management device 100. In this embodiment, the request comprises the web application identifier.

In an embodiment, the web application management device 100 is configured to initiate a runtime environment in the web browser. The runtime environment is then configured to retrieve the meta software container from the DHT based on the web application identifier. The runtime environment is also configured to load the bootstrap code in the web page to deploy the software container in the container runtime environment. The runtime environment is additionally configured to load the web application code in the web page using the web server to initialize the user interface in the web browser.

In an embodiment, the web application management device 100 is configured to load a JavaScript library as a part of a contextual communication application page of the web browser to initiate the runtime environment.

In an embodiment, the web application management device 100 is configured to initiate the runtime environment as a browser extension or plugin of the web browser.

In an embodiment, the web application management device 100 is configured to launch the runtime environment in response to detecting presence of a tangible device.

In an embodiment, the web application management device 100 is configured to transmit the web application identifier to a DHT node and receive the meta software container originating from a DHT node responsible for a range of identifier values encompassing the web application identifier.

In an embodiment, the web application management device 100 is configured to trigger the container runtime environment to retrieve a container image to deploy the software container in the container runtime environment.

In a particular embodiment, the web application management device 100 is configured to trigger the container runtime environment to download the container image from a remote image repository to deploy the software container in the container runtime environment.

In another particular embodiment, the web application management device 100 is configured to trigger the container runtime environment to retrieve the container image from the meta software container to deploy the software container in the container runtime environment.

In an embodiment, the web application management device 100 is configured to download the web application code from the web server in the deployed software container and load the web application code in a DOM element object to deploy the web application in the web browser.

In an embodiment, the web application management device 100 is configured to update meta information of the meta software container with deployment data and upload the meta information at the DHT.

In an embodiment, the web application management device 100 is configured to retrieve the meta software container comprising the bootstrap code and meta information from the DHT based on the web application identifier. The web application management device 100 is also configured to determine whether the software container has already been deployed in the container runtime environment based on the meta information. The web application management device 100 is additionally configured load, if the software container has not already been deployed, the bootstrap code in the web page to deploy the software container in the container runtime environment.

In an embodiment, the web application management device 100 is configured to remove the web application from the web page and remove the software container from the container runtime environment. The web application management device 100 is also configured to trigger the container runtime environment to store a container image in a remote image repository. The web application management device 100 is further configured to receive an updated web application identifier for the web application from the container runtime environment and upload an updated bootstrap code and the updated web application at the DHT.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

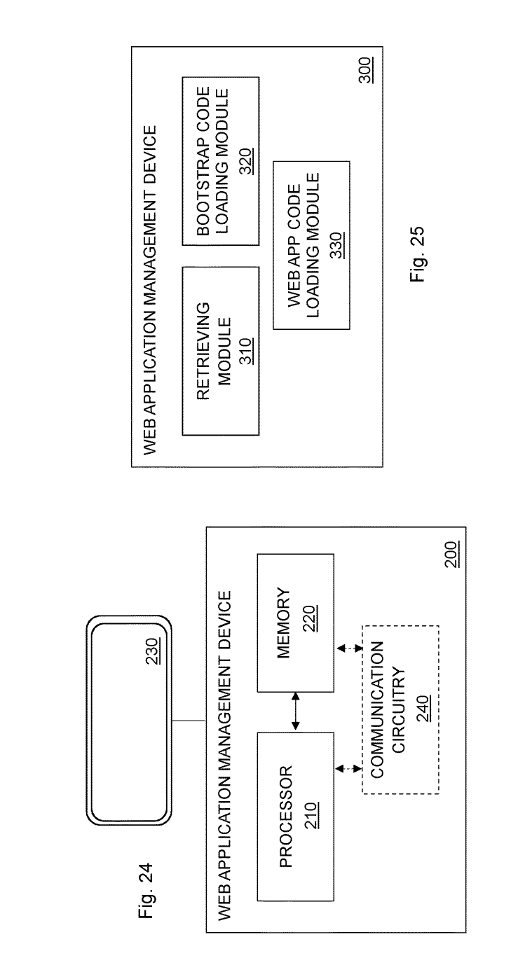

In a particular example, the web application management device 200 comprises a processor 210 and a memory 220 as shown in FIG. 24. The memory 200 comprises instructions executable by the processor 210, whereby the processor 210 is operative to retrieve the meta software container from the DHT based on the web application identifier. The processor 210 is also operative to load the bootstrap code in the web page to deploy the software container in the container runtime environment. The processor 210 is further operative to load the web application code in the web page using the web server to initialize the user interface in the web browser.

FIG. 24 also illustrates a display or screen 230 of or connected to the web application management device 200. The screen 230 may optionally be a touch-sensitive screen to thereby operate as both display and user input device. Alternatively, the web application management device 200 could be connected, either with a wire or wirelessly, to user input device, such as keypad, keyboard, mouse, etc.

In an embodiment, the web application management device 200 preferably comprises a communication circuitry 240 configured to detect presence of a tangible device and request the web application identifier from the tangible device.

The communication circuitry 240 may, for instance, be in the form of an RFID reader, a NFC reader or transceiver, a FFC reader or transceiver, an OCR or barcode scanner, a smartcard reader, etc.

The communication circuitry 240 or another communication circuitry of the web application management device 200 is preferably implemented to affect the communication with the DHT and other remote entities, such as container image repository. In such a case, the communication circuitry 240 could be in the form an input and output (I/O) port, a transceiver or a transmitter and receiver pair.

The flow diagrams presented herein may be regarded as a computer flow diagrams, when performed by one or more processors. A corresponding web application management device may be defined as a group of function modules, where each step performed by the processor corresponds to a function module. In this case, the function modules are implemented as a computer program running on the processor. Hence, the web application management device may alternatively be defined as a group of function modules, where the function modules are implemented as a computer program running on at least one processor.

The computer program residing in memory may thus be organized as appropriate function modules configured to perform, when executed by the processor, at least part of the steps and/or tasks described herein. An example of such function modules is illustrated in FIG. 25.

In the embodiment of FIG. 25, the web application management device 300 comprises a retrieving module 310 or means for retrieving a meta software container comprising bootstrap code from a DHT based on a web application identifier of a web application. The web application management device 300 also comprises a bootstrap code loading module 310 or means for loading the bootstrap code in a web page to deploy a software container in a container runtime environment. The web application management device 300 further comprises a web application code loading module 330 or means for loading web application code of the web application contained in the deployed software container in the web page using a web server in the deployed software container to initialize a user interface of the web application in a web browser.

In this particular example, at least some of the steps, functions, procedures, modules and/or blocks described herein are implemented in a computer program, which is loaded into the memory for execution by processing circuitry including one or more processors. The processor(s) and memory are interconnected to each other to enable normal software execution. An optional input/output device may also be interconnected to the processor(s) and/or the memory to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

FIG. 22 schematically illustrates a User Equipment (UE) comprising a processor 410 and a memory 430. The figure also shows a computer program 430 comprising instructions, which when executed by at least one processor 410, cause the at least one processor 410 to retrieve a meta software container comprising bootstrap code from a DHT based on a web application identifier of a web application. The at least one processor 410 is also caused to load the bootstrap code in a web page to deploy a software container in a container runtime environment. The at least processor 410 is further caused to load web application code of the web application contained in the deployed software container in the web page using a web server in the deployed software container to initialize a user interface of the web application in a web browser.

The proposed technology also provides a carrier 440 comprising the computer program 430, wherein the carrier 440 is one of an electronic signal, an optical signal, an electromagnetic signal, a magnetic signal, an electric signal, a radio signal, a microwave signal, or a computer-readable storage medium.

By way of example, the software or computer program may be realized as a computer program product, which is normally carried or stored on a computer-readable medium, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program may thus be loaded into the operating memory of a computer or equivalent processing device for execution by the processing circuitry thereof.

The web application management device of the embodiments may be in the form or housed within a general processing device or system, a computer, a laptop, a portable processing device including a portable communication device, such as a mobile telephone, a smart phone, a tablet, a Personal Digital Assistant (PDA). The UE as shown in FIG. 22 can also be selected from any of these mentioned general processing devices.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

### REFERENCES

[1] Docker-Linux Container, https://www.docker.io/, retrieved: 2014 Apr. 22

1-36. (canceled)

37. A web application management device, comprising:
communication circuitry configured to communicate with distributed hash table (DHT) nodes providing a DHT; and
processing circuitry operatively associated with the communication circuitry and configured to:
retrieve a meta software container comprising bootstrap code from said DHT, based on a web application identifier of a web application;
load said bootstrap code in a web page to deploy a software container in a container runtime environment; and
load web application code of said web application contained in said deployed software container in said web page using a web server in said deployed software container to initialize a user interface of said web application in a web browser.

38. The web application management device according to claim 37, wherein said processing circuitry is configured to:
detect presence of a tangible device; and
request said web application identifier from said tangible device.

39. The web application management device according to claim 38, wherein said processing circuitry is configured to:
display an icon in said web browser in response to detecting presence of said tangible device; and
transmit a request for said meta software container based on a user-initiated activation of said icon using a user input device connected to said web application management device, wherein said request comprises said web application identifier.

40. The web application management device according to claim 37, wherein said processing circuitry is configured to initiate a runtime environment in said web browser, wherein said runtime environment is configured to:
retrieve said meta software container from said DHT based on said web application identifier;
load said bootstrap code in said web page to deploy said software container in said container runtime environment; and
load said web application code in said web page using said web server to initialize said user interface in said web browser.

41. The web application management device according to claim 40, wherein said processing circuitry is configured load a JAVASCRIPT library as a part of a contextual communication application page of said web browser to initiate said runtime environment.

42. The web application management device according to claim 40, wherein said processing circuitry is configured to initiate said runtime environment as a browser extension or plugin of said web browser.

43. The web application management device according to claim 40, wherein said processing circuitry is configured to launch said runtime environment in said web browser in response to detecting presence of a tangible device.

44. The web application management device according to claim 37, wherein said processing circuitry is configured to:
transmit said web application identifier to a DHT node; and
receive said meta software container originating from a DHT node responsible for a range of identifier values encompassing said web application identifier.

45. The web application management device according to claim 37, wherein said processing circuitry is configured to trigger said container runtime environment to retrieve a container image to deploy said software container in said container runtime environment.

46. The web application management device according to claim 45, wherein said processing circuitry is configured to trigger said container runtime environment to download said container image from a remote image repository to deploy said software container in said container runtime environment.

47. The web application management device according to claim 45, wherein said processing circuitry is configured to trigger said container runtime environment to retrieve said container image from said meta software container to deploy said software container in said container runtime environment.

48. The web application management device according to claim 37, wherein said processing circuitry is configured to:
download said web application code from said web server in said deployed software container; and
load said web application code in a Document Object Model (DOM) element object to deploy said web application in said web browser.

49. The web application management device according to claim 37, wherein said processing circuitry is configured to:
update meta information of said meta software container with deployment data; and
upload said meta information at said DHT.

50. The web application management device according to claim 37, wherein said processing circuitry is configured to:
retrieve said meta software container comprising said bootstrap code and meta information from said DHT based on said web application identifier;
determine whether said software container has already been deployed in said container runtime environment based on said meta information; and
load, if said software container has not already been deployed, said bootstrap code in said web page to deploy said software container in said container runtime environment.

51. The web application management device according to claim 37, wherein said processing circuitry is configured to:
remove said web application from said web page;
remove said software container from said container runtime environment;
trigger said container runtime environment to store a container image in a remote image repository;
receive an updated web application identifier for said web application from said container runtime environment; and
upload updated bootstrap code and said updated web application identifier for said web application at said DHT.

52. A non-transitory computer-readable storage medium storing a computer program comprising instructions, which when executed by at least one processor of a web application management device, cause said web application management device to:
retrieve a meta software container comprising bootstrap code from a distributed hash table (DHT) provided by DHT nodes, based on a web application identifier of a web application;
load said bootstrap code in a web page to deploy a software container in a container runtime environment; and
load web application code of said web application contained in said deployed software container in said web page using a web server in said deployed software container to initialize a user interface of said web application in a web browser.
